(19) United States
(12) Patent Application Publication
(10) Pub. No.: US 2004/0013565 A1
(43) Pub. Date: Jan. 22, 2004

(54) Array of autoclaves

(76) Inventors: Boris E Bosch, Kahlenhausen 42, Koeln (DE); Thomas Riermeier, Floersheim (DE); Uwe Dingerdissen, Seecheim-Jugenheim (DE); Gerhard Geiss, Utermuehle 2, liederbach (DE); Norbert Stoll, Heide 1, Vorbeck (DE); Martin Krohn, Strasse 28, Rostock (DE); Robert Lemke, Stockholmer Strasse Rostock (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/381,588

(22) PCT Filed: Sep. 28, 2001
(86) PCT No.: PCT/EP01/11249

(30) Foreign Application Priority Data
Oct. 2, 2000 (DE) 10049078.6

(51) Int. Cl. B01J 19/00

(52) U.S. Cl. 422/38

(57) ABSTRACT

The invention relates to a scalable autoclave array for studying chemical reactions which consists of autoclave modules, which each consist of a reactor shell hermetically fastened over a reaction vessel and which can be filled with gas independently of one another via controllable autoclave valves from a pressure regulating chamber, which contains a pressure sensor and is connected via least one controllable valve to at least one gas supply and at least one gas outlet.

The invention relates to a modularly constructed autoclave array, as well as to a method for finding suitable reaction conditions and mixtures for chemical syntheses on the industrial scale.

In the reactions employed in modern industrial chemistry and biotechnology, catalysts are for the most part used nowadays. By lowering the activation energy needed for the chemical process, they allow a substantial improvement in the substance conversion. Owing to the broad application spectrum; there is need to identify and optimize new catalysts and catalytic reactions. The efficiency of the catalysts depends in this case not only on their structure but also on process parameters, such as the pressure, the temperature, the solvent and, in particular, also on co-catalysts. In the research and optimization of catalysts and catalysis processes, this entails a multiplicity of experimental runs to be carried out under defined and reproducibly adjustable reaction conditions.

It is therefore an object of the present invention to provide a device for rapidly finding suitable reaction conditions and suitable reaction batches for chemical synthesis with low consumption of the substances to be used, as well as the associated method.

The object is achieved by a scalable autoclave array which consists of autoclave modules, which each consist of a reactor shell hermetically fastened over a reaction vessel and which can be filled with gas via mutually independently controllable autoclave valves from a pressure regulating chamber, which contains a pressure sensor and is connected via least one controllable valve to at least one gas supply and at least one gas outlet.

The autoclave modules of the device consist of a reactor shell, which is connected to the associated autoclave valve, and the reaction vessel itself, which can be hermetically fastened to the shell. The hermetic connection between the reactor shell and the reaction vessel can be achieved through pressure, for example by means of a screw thread. The hermetic connection is preferably produced by means of pressure, in which case the reaction vessel may be introduced into a support screwed to the reactor shell. With the aid of such an autoclave module design, the reaction vessel which is used may be a simple, cost-efficient replaceable container. In this case, it is unimportant whether the container is used as a single- or multiple-use reaction vessel. For instance, test tubes that can be closed with a crimp or septum lid, as are often employed for analytical purposes, may be used as the reaction vessel.

All materials known to the person skilled in the art may be used as the sealing materials, depending on the reaction to be studied and the associated process conditions. For example, Teflon or Viton have been found to be useful. It is preferable to use wedge gap seals.

The reactor shell of the autoclave modules is connected to at least one controllable autoclave valve in each case. Gas-tight valves with a small dead volume, for example in binary switches, are preferred. The reactor shell may additionally contain a closable channel for filling the autoclave module with the reaction batch, or for removing the reaction products. Filling via such a channel is particularly advantageous whenever it is necessary to operate under inert gas conditions. Placement of the reaction batch in the reaction vessel is also possible.

The filling, and the removal of substances from the autoclave module for direct analysis of the reaction products, may respectively be carried out in an automated fashion, for example by a pipetting robot.

In a preferred embodiment, the autoclave modules are thermally regulatable. To that end, for example, conventional heating or cooling baths may be used. A modular autoclave array structure in which the thermal regulating is carried out by means of a channel system placed in the reactor shell, through which a cooling or heating medium can be fed, has been found to be advantageous. The channel system may be formed by bores in the reactor shell. If the individual autoclave modules are hermetically connected to one another, then module-spanning channel systems can readily be produced, depending on the configuration of the bore. It is preferable for the bore to lie as close as possible to the reactor shell inner wall, in order to insure rapid thermal regulating of the reaction vessel.

In a particular preferred embodiment, scalable autoclave rows, with a module-spanning channel system for thermal regulating, are hermetically assembled from the autoclave modules plug-in connections. Each autoclave row can hence be thermally regulated independently of one another. A great advantage of such a channel system is the rapid thermal regulating of the reaction vessels, both heating and cooling of the autoclave modules being possible. In this case, the number of modules used remains freely selectable, and the autoclave array device is hence easily scalable.

The individual autoclave modules are connected to pressure regulating chamber via a mutually independently controllable autoclave valve in each case. The desired setpoint pressure can be adjusted in the pressure regulating chamber via the dosable gas supply. The desired pressure can be produced independently of one another in the autoclave modules by successively opening the autoclave valves after adjustment of the respectively desired setpoint pressure. In this case, it is advantageous for the reaction space, consisting of the reaction vessel volume apart from the autoclave valve, to be small compared with the volume of the pressure regulating chamber. The pressure adjustment in the individual autoclave modules can be cyclically repeated. With the aid of this time division multiplex adjustment of the reaction pressure, a constant reaction pressure can be adjusted as required by readjustment. Isobaric reaction control is possible without extra outlay. Is furthermore possible to produce a pressure gradient by variation of the setpoint pressure for an autoclave module.

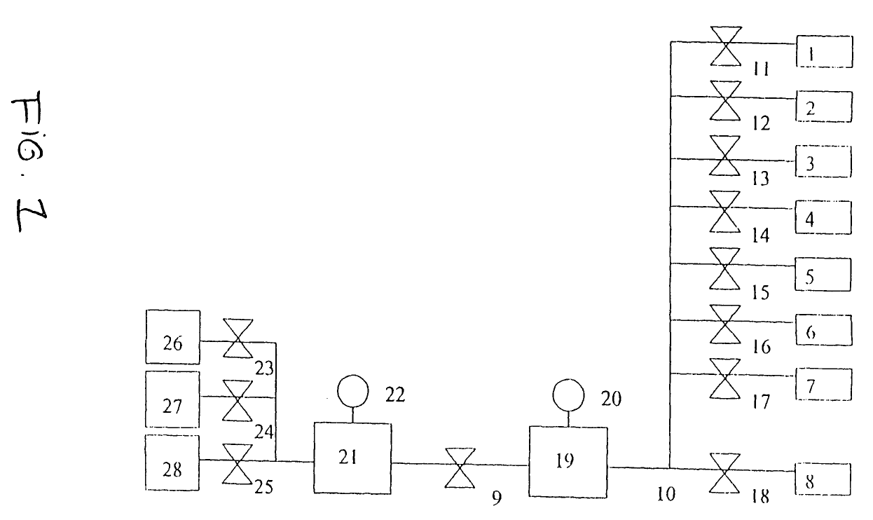

In a refined embodiment of the device according to the invention, a reference volume chamber, which is connected to the pressure regulating chamber via controllable valves, is provided between the individual autoclave valves and the pressure regulating chamber. With the aid of such a device, it is possible to determine the consumption of reaction gas in the individual autoclave modules. The reference volume chamber has a precisely defined volume, i.e. the reference volume. The reference volume chamber and the autoclave modules can be filled with gas from pressure regulating chamber, up to a pre-determinable setpoint pressure, via the controllable opened valves. Here again, the pressure adjustment of the individual autoclave modules can be carried out independently of one another. With the autoclave valves closed, a freely selectable reaction gas setpoint pressure can then be adjusted in the reference volume chamber via the pressure regulating chamber. After closing the valves to the pressure regulating chamber, an autoclave module valve can be opened and the pressure difference in the reference volume chamber is determined via a pressure sensor, which measures the prevailing actual pressure after opening of the autoclave valve. The pressure difference can be correlated via the gas law with the volume of the reaction gas that has flowed into the autoclave module. Through the time division multiplex measurement of the pressure differences between a setpoint pressure and the actual pressure, it is possible to monitor the consumption of reaction gas for each autoclave module independently of one another in a time-resolved fashion. A scalable autoclave array constructed in such a way is particularly suitable for the parallelized study of reactions with at least one gaseous educt. FIG. 1 shows, for illustration, an embodiment of the autoclave array according to the invention with a reference volume chamber.

The autoclave array which is used consists, in this embodiment, of an autoclave row with 1×8 individual reactors, i.e. the autoclave modules (1)-(8). The individual autoclave modules are connected via a line system (10) to the reference volume chamber (19) via one autoclave module valve (11)-(18) each. The actual-pressure measurement is carried out on the reference volume chamber (19) via a pressure sensor (20). The reference volume chamber (19) is connected to the pressure regulating chamber via a valve (9). The pressure in the pressure regulating chamber is determined by means of a pressure sensor (22). The pressure regulating chamber (21) is furthermore connected via a valve (24) to an inert gas reservoir (27), via a valve (25) to a reaction gas reservoir (28) and via a valve (23) to a gas-outlet/vacuum system (26) through the line system (10).

Continuous measurement of the pressure drop is possible with additional pressure sensors, which are fitted between the autoclave valve and the reactor shell. It is also conceivable, albeit technically more elaborate, to put a pressure sensor in the autoclave module itself.

The adjustment of the setpoint pressure is carried via a valve gas supply that can be dosed by a valve, and via a gas outlet that can be dosed by a valve; a vacuum pump may additionally be attached. It is also possible to attach a plurality of independently regulatable gas supplies and gas outlets to the pressure regulating chamber.

An independent inert gas supply, for example, is advantageous. With the aid of such a supply, especially in conjunction with a vacuum pump which is also attached, the device can be placed under an inert gas. This makes it possible to carry out chemical reactions in the device entirely under inert reaction conditions.

The individual autoclave modules respectively be provided with a stirring device for homogenizing the reaction batches. In this case, electromagnetic stirring or stirring via a vibrating rod, which consists of a flexible tube that is closed on the lower side and is hermetically attached via an opening located in the reactor shell, is preferable. Through the opening, the vibrating rod can be set in vibration with a slightly bent rotating rod extending into the tube. This stirring system has the advantage that no components extend through the autoclave inner wall into the interior, so that no sealing of the access is necessary. The avoidance of dead volumes which, for example, is inevitable when using a conventional stirring rod, is also advantageous especially in respect of miniaturized autoclaves.

With such a scalable autoclave array, defined conditions in terms of temperature and pressure can be adjusted in each autoclave module. This allows a high parallelization level of the studiable reaction batches. Especially in combination with the already comprehensively available combinatorial synthesis methods for producing catalysts, a highly parallel-operating device for studying the catalyst activity under different reaction conditions is advantageous. Through the scalability, the autoclave array remains variable terms of the number of reaction modules which can be used. The device according to the invention is furthermore miniaturizable. Owing to the possibility of a time division multiplex module-specific gas supply, the reaction conditions can be kept approximately constant. Owing to the autoclave array design, the process control and the measurement methodology, the results obtained are applicable to industrial processes, with the often elaborate and expensive technical scaling processes being shortened or entirely obviated. Furthermore, the necessary material outlay and the concomitant amount of waste products during the experimental evaluation of a chemical reaction is very small. Autoclave module volumes of less than 100 ml are in this case unproblematic, and reactions can even be carried out reproducibly in modules with a 1 ml volume. A further advantage of the device according to the invention is that the autoclave array can produce reproducible reaction conditions in a very wide temperature range and pressure range. Through the advantageous design of the autoclave array, all the autoclave modules can be filled with gases via only one pressure regulating chamber, or via one reference volume chamber. In particular through the combination of a pressure regulating chamber and a reference volume chamber, the pressure adjustment and the pressure-difference measurement can be carried out very accurately and rapidly, which is advantageous in particular for studying small reaction batches.

The invention furthermore relates to a method for the parallelized study of chemical reactions by using said autoclave array devices.

The reaction batches may to that end be placed in the reaction vessel before fastening to the reactor shell. If there is a closable channel in the reactor shell, then chemical substances may be supplied before or during the reaction to be studied, optionally in countercurrent flow.

The pressure adjustment in the individual autoclave modules, whose valves are open, is carried out via controlled opening of the gas supply and of the gas outlets and the desired setpoint pressure has been adjusted in the accessible space. The real pressure is determined via a pressure sensor, which is located in the pressure regulating chamber, and is compared with the predetermined setpoint pressure. If the measured real pressure is equal to the setpoint pressure, the autoclave valves are closed. The cycle is repeated for the pressure adjustment in the other autoclave modules.

It is advantageous, especially if the autoclave module volume is small compared with the volume of the pressure regulating chamber, to adjust the setpoint pressure in the device with the autoclave valve closed, before blocking the gas supply and the gas outlet, including any vacuum pump which may be present, and subsequently to adjust the pressure in the module by opening one or more autoclave module valves. The pressure equilibration between the pressure regulating chamber then takes place very rapidly and, if there is an overpressure in the pressure regulating chamber, a gas flow takes place only into the autoclave module, so that any possible diffusion of substances out of the reaction vessel into the pressure regulating chamber is minimized.

Time division multiplex pressure regulating is subsequently carried out in the individual autoclave modules. In this case, according to a predeterminable pressure program, the respective setpoint pressure in the pressure regulating chamber is adjusted, then the gas supply and the gas outlet are blocked. By opening the respective autoclave module valve, pressure equilibration between the pressure regulating chamber and the autoclave module, and blocking the autoclave module valve, the pressure in the module is then set according to the predetermined pressure program. The sequence is repeated for the individual autoclave modules, then a new pressure regulating cycle can begin.

After the reaction has ended, the pressure is released from the device via the gas outlet, and the reaction batches can then be removed for analysis.

The method according to the invention hence comprises the following method steps:

a) introduction of individual reaction batches into the autoclave modules,

b) successive adjustment of the setpoint pressures in the respective autoclave modules,

c) time division multiplex regulating of the pressures in the autoclave modules,

relaxation of the gas pressure in the device and removal of the reaction products for analysis.

In a refined method, the actual pressure is additionally determined after regulating the pressure in the autoclave module, with the gas supply blocked and the gas outlet blocked. From the difference between the measure actual pressure and the setpoint pressure, the gas volume which has flowed into the autoclave module is then determined for a given temperature. This method variant is advantageous, in particular, when studying a chemical reaction in which at least one gaseous educt involved. In reaction gas is in this case supplied to the autoclaves via the pressure regulating chamber.

In a particularly advantageous embodiment of the inventive method, the gas consumption measurement is carried out via a reference volume chamber connected between the pressure regulating chamber and the autoclave modules. To that end, the setpoint pressure is adjusted via pressure regulating chamber with the autoclave module valves closed. After blocking the reference volume chamber in relation to the pressure regulating chamber, the valve to the autoclave module to be set can be opened. The measurement of the actual pressure after pressure equilibration between the reference volume chamber and the autoclave module is carried out via a pressure sensor built into the reference volume chamber.

The pressure regulating chamber represents a defined gas volume, in which the reaction setpoint pressures to be adjusted in the reference volume chamber and in the pressure regulating chamber are iteratively corrected for the 8 autoclaves, while the equilibration process between the autoclave and the reference volume is still taking place. Then the valve between the reference volume chamber and the pressure regulating chamber transfers the pressure to the former and the process is repeated cyclically.

With the aid of this method, pressure regulating and the gas consumption measurement can consequently take place in one method step, with high accuracy and under reproducible conditions. Owing to the rapid pressure adaptation in the autoclave modules, constancy of the reaction pressure is insured throughout the reaction process.

The gas consumption measurement is determined as an integral of the pressure differences describing the gas consumption with respect to the reaction time for each individual reactor.

A further advantage of the described autoclave array is that it permits continuous reaction control under an inert gas. To that end, the device is evacuated via a vacuum pump attached to the pressure regulating chamber, and sequentially receives an inert gas via a gas supply. The process can be repeated several times. With the autoclave module valves open, the reaction batch can then be introduced under an inert gas countercurrent flow via a closable channel placed in the reactor shell, then the channel is closed and the autoclave module valve is blocked. The reaction batch is now ready in the autoclave module under an inert gas. The device can subsequently be operated, as required, still with inert gas for pressure regulating or with a separately suppliable reaction gas. After completion of the reaction, the device can again be put under an inert gas, and sampling of the reaction products can in turn take place in an inert gas countercurrent flow via the reactor shell channel with the autoclave module valve open.

It is also possible to take samples from the individual autoclave modules during the reaction. To that end, however, the gas pressure in the respective autoclave needs to be relaxed via the gas outlet, then a sample can be taken via the channel in the reactor shell, optionally in a gas countercurrent flow.

### EXEMPLARY EMBODIMENTS

Autoclave Array Used:

The examples of studied reactions presented below were carried out with an autoclave array according to FIG. 1. The stainless steel autoclave modules used had a reaction volume of 3 ml. Test tubes with a crimp closure were used as reaction vessels. The individual autoclave modules were hermetically combined to form a 1×8 autoclave row. The temperature regulating is carried out via a channel system placed in the reactor shell with a medium that can be heated via a thermostat. The reliable, intense and modulatable homogenization of the reactants is carried out by indirect magnetic stirring by means of rotating field transfer through the nonmagnetic autoclave bottom.

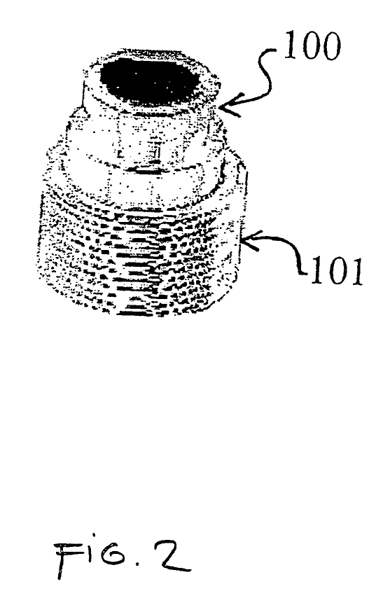

Easy accessibility of the samples after the reaction, with contamination to be avoided, and coupling to analytical methods is insured through the embodiment of the autoclaves as axisymmetric single-use reaction vessels (100) in a sleeve (101) screwed into the reactor shell (FIG. 2). The securability in the form of evacuation of the system and the possibility of flushing with an inert gas is insured via a short-circuit function of the pressure regulating section or of the reference volume.

The reaction-pressure adjustment with the reactant gas is insured with the aid of the pressure sensors in the pressure regulating section and the reference volume of via a pressure regulating chamber—reference volume chamber—autoclave module valve combination.

A gas-tight binary switch with a small dead volume and short opening and closing times is used as the autoclave module valve.

Reproducible conditions can readily be achieved with such an autoclave array in a temperature range of from −50 to 200° C. and a pressure range of from 0 to 200 bar.

Procedure:

The volumes indicated in Table 1 of a 0.3 M solution of the substrate (N-acetyl-2-phenyl-1-ethenylamine (APEA), methyl itaconate (ISME), methyl acetamidocinnamate (AAZSE)) in MeOH with the volumes indicated in Table 1 of a 0.01 M catalyst solution (bis-(1,5-cyclooctadiene)rhodium(I) triflate (Rh(COD)2OTf)/1,2-bis[(2R,5R)-2,5- diethylphospholano]benzene (R,R-EtDuPHOS) in the quantity ratio 1:1.1 and the solvent volume indicated in the table) in MeOH were combined under an inert gas in the thermally regulated reaction vessel in the autoclave modules (reactors R1-R8). After the inert gas had been removed via the vacuum pump, the hydrogen pressure indicated in the table was applied. After the end of the reaction time, the reaction gas (hydrogen) was pumped off and the autoclaves were flushed with an inert gas. Analysis of the reaction batches with standard GC (conversion C) and HPLC (enantiomer abundance ea) was subsequently carried out.

The results are collated in Table 1.

The individual reaction batches are studied in the autoclave array according to the following method program:

a) thermally regulating the autoclave modules

b) repeatedly flushing and securing the entire gas supply line system with inert gas (Ar),

c) flushing the autoclave modules with inert gas (Ar) in countercurrent flow

d) opening the screwable reactor shell channel,

e) filling the autoclave modules by means of injection under a slight Ar countercurrent flow via the open reactor shell channel,

f) hermetically closing the reactor shell channel,

g) stopping the flushing with inert gas,

h) securing the autoclave modules by relaxing the Ar overpressure, evacuating the autoclave modules for 1 s and filling with reaction gas 1 bar,

i) filling the individual autoclave modules with reaction gas according to the setpoint pressure specification,

j) measuring the actual pressures in the individual autoclave modules after completion of the reaction,

k) relaxation of the autoclave array device,

l) removal of the reaction vessels for analysis.

To check the applicability to larger reaction batches, a reaction batch made up of 15 ml AAZSE (0.5 M in MeOH) was combined with 1.5 ml of a catalyst solution of Rh(COD)2OTf/R,R-EtDuPHOS (1:1.1 in MeOH) and 21.0 ml MeOH under an inert gas and reacted in a 50 ml autoclave at a pressure of 5 bar and a temperature of 25° C. in a similar way to Test No. 5 in Table 1. The reaction time was 2 hours. Conversion 100%, educt proportion enantiomer 1 96.2845 liq. %, enantiomer 2 1.8142 liq. %, ea 96.3%. The results of the studied reactions in the autoclave array device according to the invention are therefore applicable to larger reaction vessels.

| | | Sub- | | | Sol. | | | | | | | | |
|---|---|---|---|---|---|---|---|---|---|---|---|---|---|
| Test | Ratio | strate | MPC | Ligand | With | Time | Temp. | Pressure | | GC (liq. %) | | HPLC (liq. %) | |
| No. | Sub/MPC/Lig | μl | μl | μl | M1 | h | ° C. | bar | Reactor | educt | product | “1” | “2” |

| | | | | | | | | | | | | |
|---|---|---|---|---|---|---|---|---|---|---|---|---|
| 1 | 100/1/1.1 | AAZSE | Rh(COD)2OTf/EtDuPHOS | MeOH | 1 | 25 | 5 | Block | 0.00 | 98.36 | 96.8070 | 1.7072 |
| | | 800 | 400 | 800 | | | | R1 | C: | 100.0% | ea: | 96.5% |
| 1 | 100/1/1.1 | AAZSE | Rh(COD)2OTf/EtDuPHOS | MeOH | 1 | 25 | 5 | Block | 0.00 | 98.24 | 96.7723 | 1.4897 |
| | | 800 | 400 | 800 | | | | R2 | C: | 100.0% | ea: | 97.0% |
| 1 | 100/1/1.1 | AAZSE | Rh(COD)2OTf/EtDuPHOS | MeOH | 1 | 25 | 5 | Block | 0.00 | 98.21 | 96.8007 | 1.4879 |
| | | 800 | 400 | 800 | | | | R3 | C: | 100.0% | ea: | 97.0% |
| 1 | 100/1/1.1 | AAZSE | Rh(COD)2OTf/EtDuPHOS | MeOH | 1 | 25 | 5 | Block | 0.00 | 98.36 | 96.4958 | 1.9871 |
| | | 800 | 400 | 800 | | | | R4 | C: | 100.0% | ea: | 96.0% |
| 1 | 100/1/1.1 | AAZSE | Rh(COD)2OTf/EtDuPHOS | MeOH | 1 | 25 | 5 | Block | 0.00 | 98.28 | 96.7457 | 1.6593 |
| | | 800 | 400 | 800 | | | | R5 | C: | 100.0% | ea: | 96.6% |
| 1 | 100/1/1.1 | AAZSE | Rh(COD)2OTf/EtDuPHOS | MeOH | 1 | 25 | 5 | Block | 0.00 | 97.87 | 96.3974 | 1.7553 |
| | | 800 | 400 | 800 | | | | R6 | C: | 100.0% | ea: | 96.4% |
| 1 | 100/1/1.1 | AAZSE | Rh(COD)2OTf/EtDuPHOS | MeOH | 1 | 25 | 5 | Block | 0.00 | 98.24 | 96.9669 | 1.8812 |
| | | 800 | 400 | 800 | | | | R7 | C: | 100.0% | ea: | 96.2% |
| 1 | 100/1/1.1 | AAZSE | Rh(COD)2OTf/EtDuPHOS | MeOH | 1 | 25 | 5 | Block | 0.00 | 98.36 | 96.8477 | 2.1287 |
| | | 800 | 400 | 800 | | | | R8 | C: | 100.0% | ea: | 95.7% |
| 2 | 1000/1/1.1 | AAZSE | Rh(COD)2OTf/EtDuPHOS | MeOH | 3 | 25 | 5 | Block | 0.04 | 98.69 | 98.1075 | 1.5995 |
| | | 800 | 40 | 1160 | | | | R1 | C: | 100.0% | ea: | 96.8% |
| 2 | 1000/1/1.1 | AAZSE | Rh(COD)2OTf/EtDuPHOS | MeOH | 3 | 25 | 5 | Block | 0.03 | 98.69 | 98.2781 | 1.4260 |
| | | 800 | 40 | 1160 | | | | R2 | C: | 100.0% | ea: | 97.1% |
| 2 | 1000/1/1.1 | AAZSE | Rh(COD)2OTf/EtDuPHOS | MeOH | 3 | 25 | 5 | Block | 0.08 | 98.62 | 98.0407 | 1.6316 |
| | | 800 | 40 | 1160 | | | | R3 | C: | 99.9 | ea: | 96.7% |
| 2 | 1000/1/1.1 | AAZSE | Rh(COD)2OTf/EtDuPHOS | MeOH | 3 | 25 | 5 | Block | 0.00 | 98.71 | 98.0151 | 1.6812 |
| | | 800 | 40 | 1160 | | | | R4 | C: | 100.0% | ea: | 96.6% |
| 2 | 1000/1/1.1 | AAZSE | Rh(COD)2OTf/EtDuPHOS | MeOH | 3 | 25 | 5 | Block | 2.24 | 96.52 | 87.6692 | 1.8533 |
| | | 800 | 40 | 1160 | | | | R5 | C: | 97.7 | ea: | 95.9% |
| 2 | 1000/1/1.1 | AAZSE | Rh(COD)2OTf/EtDuPHOS | MeOH | 3 | 25 | 5 | Block | 22.76 | 75.94 | 39.7352 | 0.9657 |
| | | 800 | 40 | 1160 | | | | R6 | C: | 76.9 | ea: | 95.3% |
| 2 | 1000/1/1.1 | AAZSE | Rh(COD)2OTf/EtDuPHOS | MeOH | 3 | 25 | 5 | Block | 0.21 | 98.45 | 97.8641 | 1.7444 |
| | | 800 | 40 | 1160 | | | | R7 | C: | 99.8 | ea: | 96.5% |
| 2 | 1000/1/1.1 | AAZSE | Rh(COD)2OTf/EtDuPHOS | MeOH | 3 | 25 | 5 | Block | 0.09 | 98.59 | 97.8102 | 1.8442 |
| | | 800 | 40 | 1160 | | | | R8 | C: | 99.9 | ea: | 96.3% |
| 3 | 1000/1/1.1 | AAZSE | Rh(COD)2OTf/EtDuPHOS | MeOH | 3 | 25 | 5 | Block | 0.00 | 99.57 | 98.4629 | 0.9726 |
| | | 800 | 40 | 1160 | | | | R1 | C: | 100.0% | ea: | 98.0% |
| 3 | 1000/1/1.1 | AAZSE | Rh(COD)2OTf/EtDuPHOS | MeOH | 3 | 25 | 5 | Block | 0.00 | 99.55 | 98.3238 | 1.0021 |
| | | 800 | 40 | 1160 | | | | R2 | C: | 100.0% | ea: | 98.0% |
| 3 | 1000/1/1.1 | AAZSE | Rh(COD)2OTf/EtDuPHOS | MeOH | 3 | 25 | 5 | Block | 0.00 | 99.55 | 98.3320 | 1.0224 |
| | | 800 | 40 | 1160 | | | | R3 | C: | 100.0% | ea: | 97.9% |
| 3 | 1000/1/1.1 | AAZSE | Rh(COD)2OTf/EtDuPHOS | MeOH | 3 | 25 | 5 | Block | 0.00 | 99.54 | 98.2273 | 1.0858 |
| | | 800 | 40 | 1160 | | | | R4 | C: | 100.0% | ea: | 97.8% |
| 3 | 1000/1/1.1 | AAZSE | Rh(COD)2OTf/EtDuPHOS | MeOH | 3 | 25 | 5 | Block | 0.05 | 99.50 | 98.4293 | 1.0777 |
| | | 800 | 40 | 1160 | | | | R5 | C: | 99.9% | ea: | 97.8% |
| 3 | 1000/1/1.1 | AAZSE | Rh(COD)2OTf/EtDuPHOS | MeOH | 3 | 25 | 5 | Block | 0.06 | 99.50 | 98.4060 | 1.0938 |
| | | 800 | 40 | 1160 | | | | R6 | C: | 99.9% | ea: | 97.8% |
| 3 | 1000/1/1.1 | AAZSE | Rh(COD)2OTf/EtDuPHOS | MeOH | 3 | 25 | 5 | Block | 0.04 | 99.52 | 98.8574 | 1.1426 |
| | | 800 | 40 | 1160 | | | | R7 | C: | 100.0% | ea: | 97.7% |
| 3 | 1000/1/1.1 | AAZSE | Rh(COD)2OTf/EtDuPHOS | MeOH | 3 | 25 | 5 | Block | 0.00 | 99.52 | 87.1596 | 1.2449 |
| | | 800 | 40 | 1160 | | | | R8 | C: | 100.0% | ea: | 97.5% |
| 4 | 1000/1/1.1 | AAZSE | Rh(COD)2OTf/EtDuPHOS | MeOH | 3 | 25 | 5 | Block | 0.03 | 99.19 | 98.4220 | 1.4127 |
| | | 800 | 40 | 1160 | | | | R1 | C: | 100.0% | ea: | 97.2% |
| 4 | 1000/1/1.1 | AAZSE | Rh(COD)2OTf/EtDuPHOS | MeOH | 3 | 25 | 5 | Block | 0.05 | 99.14 | 98.4780 | 1.3746 |
| | | 800 | 40 | 1160 | | | | R2 | C: | 99.9% | ea: | 97.2% |
| 4 | 1000/1/1.1 | AAZSE | Rh(COD)2OTf/EtDuPHOS | MeOH | 3 | 25 | 5 | Block | 0.11 | 99.08 | 98.3352 | 1.5134 |
| | | 800 | 40 | 1160 | | | | R3 | C: | 99.9% | ea: | 97.0% |
| 4 | 1000/1/1.1 | AAZSE | Rh(COD)2OTf/EtDuPHOS | MeOH | 3 | 25 | 5 | Block | 0.02 | 99.17 | 98.3844 | 1.4608 |
| | | 800 | 40 | 1160 | | | | R4 | C: | 100.0% | ea: | 97.1% |
| 4 | 1000/1/1.1 | AAZSE | Rh(COD)2OTf/EtDuPHOS | MeOH | 3 | 25 | 5 | Block | 0.11 | 99.06 | 98.3513 | 1.4980 |
| | | 800 | 40 | 1160 | | | | R5 | C: | 99.9% | ea: | 97.9% |
| 4 | 1000/1/1.1 | AAZSE | Rh(COD)2OTf/EtDuPHOS | MeOH | 3 | 25 | 5 | Block | 0.91 | 98.29 | 92.5115 | 1.5086 |
| | | 800 | 40 | 1160 | | | | R6 | C: | 99.1% | ea: | 96.8% |
| 4 | 1000/1/1.1 | AAZSE | Rh(COD)2OTf/EtDuPHOS | MeOH | 3 | 25 | 5 | Block | 8.43 | 90.76 | 60.7452 | 0.9904 |
| | | 800 | 40 | 1160 | | | | R7 | C: | 91.5% | ea: | 96.8% |
| 4 | 10001/1.1 | AAZSE | Rh(COD)2OTf/EtDuPHOS | MeOH | 3 | 25 | 5 | Block | 2.06 | 97.15 | 85.4040 | 1.4602 |
| | | 800 | 40 | 1160 | | | | R8 | C: | 97.9% | ea: | 96.6% |
| 5 | 500/1/1.1 | AAZSE | Rh(COD)2OTf/EtDuPHOS | MeOH | 2 | 25 | 5 | Block | 0.04 | 99.08 | 97.8947 | 1.4059 |
| | | 800 | 80 | 1120 | | | | R1 | C: | 100.0% | ea: | 97.2% |
| 5 | 500/1/1.1 | AAZSE | Rh(COD)2OTf/EtDuPHOS | MeOH | 2 | 25 | 5 | Block | 0.04 | 99.02 | 97.4521 | 1.4390 |
| | | 800 | 80 | 1120 | | | | R2 | C: | 100.0% | ea: | 97.1% |
| 5 | 500/1/1.1 | AAZSE | Rh(COD)2OTf/EtDuPHOS | MeOH | 2 | 25 | 5 | Block | 0.05 | 99.03 | 98.2114 | 1.5857 |
| | | 800 | 80 | 1120 | | | | R3 | C: | 99.9% | ea: | 96.8% |
| 5 | 500/1/1.1 | AAZSE | Rh(COD)2OTf/EtDuPHOS | MeOH | 2 | 25 | 5 | Block | 0.02 | 99.06 | 97.9745 | 1.5596 |
| | | 800 | 80 | 1120 | | | | R4 | C: | 100.0% | ea: | 96.9% |
| 5 | 500/1/1.1 | AAZSE | Rh(COD)2OTf/EtDuPHOS | MeOH | 2 | 25 | 5 | Block | 0.04 | 99.04 | 98.2552 | 1.5413 |
| | | 800 | 80 | 1120 | | | | R5 | C: | 100.0% | ea: | 96.7% |
| 5 | 500/1/1.1 | AAZSE | Rh(COD)2OTf/EtDuPHOS | MeOH | 2 | 25 | 5 | Block | 0.20 | 98.68 | 96.8726 | 1.6355 |
| | | 800 | 80 | 1120 | | | | R6 | C: | 99.8% | ea: | 96.5% |
| 5 | 500/1/1.1 | AAZSE | Rh(COD)2OTf/EtDuPHOS | MeOH | 2 | 25 | 5 | Block | 6.23 | 92.85 | 65.9572 | 1.1678 |
| | | 800 | 80 | 1120 | | | | R7 | C: | 93.7% | ea: | 96.5% |
| 5 | 500/1/1.1 | AAZSE | Rh(COD)2OTf/EtDuPHOS | MeOH | 2 | 25 | 5 | Block | 0.10 | 99.00 | 98.0412 | 1.7645 |
| | | 800 | 80 | 1120 | | | | R8 | C: | 99.9% | ea: | 96.5% |
| 6 | 100/1/1.1 | ISME | Rh(COD)2OTf/EtDuPHOS | MeOH | 2 | 40 | 10 | Block | 0.00 | 99.60 | 81.4564 | 3.9633 |
| | | 1000 | 300 | 700 | | | | R1 | C: | 100.0% | ea: | 90.7% |
| 6 | 100/1/1.1 | ISME | Rh(COD)2OTf/EtDuPHOS | MeOH | 2 | 40 | 10 | Block | 0.00 | 99.56 | 79.4779 | 4.9418 |
| | | 1000 | 300 | 700 | | | | R2 | C: | 100.0% | ea: | 88.3% |
| 6 | 500/1/1.1 | ISME | Rh(COD)2OTf/EtDuPHOS | MeOH | 2 | 40 | 10 | Block | 0.00 | 99.53 | 74.6982 | 7.9007 |
| | | 1000 | 60 | 940 | | | | R3 | C: | 100.0% | ea: | 80.9% |
| 6 | 500/1/1.1 | ISME | Rh(COD)2OTf/EtDuPHOS | MeOH | 2 | 40 | 10 | Block | 0.00 | 99.77 | 77.7711 | 6.1334 |
| | | 1000 | 60 | 940 | | | | R4 | C: | 100.0% | ea: | 85.4% |
| 6 | 500/1/1.1 | ISME | Rh(COD)2OTf/EtDuPHOS | MeOH | 2 | 40 | 10 | Block | 0.00 | 99.76 | 62.4651 | 16.3204 |
| | | 1000 | 60 | 940 | | | | R5 | C: | 100.0% | ea: | 58.6% |
| 6 | 1000/1/1.1 | ISME | Rh(COD)2OTf/EtDuPHOS | MeOH | 2 | 40 | 10 | Block | 1.66 | 98.06 | 56.0930 | 7.4812 |
| | | 1000 | 30 | 970 | | | | R6 | C: | 98.3% | ea: | 76.5% |
| 6 | 500/1/1.1 | ISME | Rh(COD)2OTf/EtDuPHOS | MeOH | 2 | 40 | 10 | Block | 0.00 | 99.49 | 67.2591 | 9.4100 |
| | | 1000 | 60 | 940 | | | | R7 | C: | 100.0% | ea: | 75.5% |
| 6 | 1000/1/1.1 | ISME | Rh(COD)2OTf/EtDuPHOS | MeOH | 2 | 40 | 10 | Block | 29.74 | 69.98 | 11.1186 | 2.8663 |
| | | 1000 | 30 | 970 | | | | R8 | C: | 70.2% | ea: | 59.0% |
| 7 | 100/1/1.1 | APEA | Rh(COD)2OTf/EtDuPHOS | MeOH | 2 | 40 | 10 | Block | 0.00 | 97.96 | 88.5352 | 7.0216 |
| | | 1000 | 300 | 700 | | | | R1 | C: | 100.0% | ea: | 85.3% |
| 7 | 100/1/1.1 | APEA | Rh(COD)2OTf/EtDuPHOS | MeOH | 2 | 40 | 10 | Block | 0.00 | 97.66 | 88.8800 | 6.8971 |
| | | 1000 | 300 | 700 | | | | R2 | C: | 100.0% | ea: | 85.6% |
| 7 | 100/1/1.1 | APEA | Rh(COD)2OTf/EtDuPHOS | MeOH | 2 | 40 | 10 | Block | 0.00 | 97.73 | 88.8018 | 7.3028 |
| | | 1000 | 300 | 700 | | | | R3 | C: | 100.0% | ea: | 84.8% |
| 7 | 100/1/1.1 | APEA | Rh(COD)2OTf/EtDuPHOS | MeOH | 2 | 40 | 10 | Block | 0.00 | 97.77 | 88.5562 | 7.5008 |
| | | 1000 | 300 | 700 | | | | R4 | C: | 100.0% | ea: | 84.4% |
| 7 | 500/1/1.1 | APEA | Rh(COD)2OTf/EtDuPHOS | MeOH | 2 | 40 | 10 | Block | 0.00 | 97.87 | 86.8139 | 6.3622 |
| | | 1000 | 60 | 940 | | | | R5 | C: | 100.0% | ea: | 86.3% |
| 7 | 500/1/1.1 | APEA | Rh(COD)2OTf/EtDuPHOS | MeOH | 2 | 40 | 10 | Block | 0.00 | 97.87 | 86.7736 | 6.3200 |
| | | 1000 | 60 | 940 | | | | R6 | C: | 100.0% | ea: | 86.4% |
| 7 | 500/1/1.1 | APEA | Rh(COD)2OTf/EtDuPHOS | MeOH | 2 | 40 | 10 | Block | 0.00 | 97.97 | 85.7274 | 7.2346 |
| | | 1000 | 60 | 940 | | | | R7 | C: | 100.0% | ea: | 84.4% |
| 7 | 500/1/1.1 | APEA | Rh(COD)2OTf/EtDuPHOS | MeOH | 2 | 40 | 10 | Block | 0.00 | 98.01 | 85.6921 | 7.3187 |
| | | 1000 | 60 | 940 | | | | R8 | C: | 100.0% | ea: | 84.3% |

Legend for FIG. 1

1-8: autoclaves 1 . . . n

9 valve: pressure regulating section

10 line system

11-18 autoclave module valves 1 . . . n

19 reference volume chamber

20 actual-pressure sensor for reference volume

21 pressure regulating section

22 pressure sensor: pressure regulating section

23 valve: gas outlet/vacuum system

24 valve: inert gas supply

25 valve: reaction gas supply

26 gas outlet/vacuum system

27 inert gas reservoir

28 reaction gas reservoir

1. Device for studying chemical reactions, characterized in that a scalable autoclave array made up of autoclave modules, each consisting of a reactor shell which is hermetically fastened over a reaction vessel and which is in each case connected via a controllable autoclave valve to a pressure regulating chamber containing a pressure sensor, the pressure regulating chamber being connected via least one controllable valve to at least one gas supply and at least one gas outlet.

2. The method as claimed in claim 1, characterized in that a pressure sensor is fitted between the autoclave valve and the reactor shell for continuous measurement of the pressure change in the autoclave modules.

3. The device as claimed in one of the preceding claims, characterized in that a reference volume chamber containing a pressure sensor lies via controllable valves between the pressure regulating chamber and the autoclave valves.

4. The device as claimed in one of the preceding claims, characterized in that the reference volume chamber or the regulating chamber is also connected to an inert gas supply via a controllable valve.

5. The device as claimed in one of the preceding claims, characterized in that a vacuum pump is fitted to the gas outlet, to the reference volume chamber or to the pressure regulating chamber.

6. The device as claimed in one of the preceding claims, characterized in that the autoclave modules are thermally regulatable.

7. The device as claimed in claim 6, characterized in that the autoclave modules are thermally regulatable via a channel system placed in the reactor shells.

8. The device as claimed in claim 7, characterized in that the channel system is formed by channels bored in the reactor shell, the autoclave modules being hermetically connectable to one another.

9. The device as claimed in one of the preceding claims, characterized in that the reaction vessels are replaceable or single-use containers.

10. The device as claimed in one of the preceding claims, characterized in that the reaction modules are equipped with a stirring device.

11. The device as claimed in one of the preceding claims, characterized in that a magnetic stirring device or a vibrating rod stirrer is used.

12. The device as claimed in one of the preceding claims, characterized in that the controllable valves, autoclave valves and/or the pressure sensors and/or the thermostat and/or the stirrer are connected to an electronic control and measurement device.

13. The device as claimed in one of the preceding claims, characterized in that the reaction modules have a reaction space volume of less than 100 ml.

14. The device as claimed in one of the preceding claims, characterized in that the reaction modules have a reaction space volume of between 1 ml and 10 ml.

15. The device as claimed in one of the preceding claims, characterized in that the range shell of the individual reaction modules has a closable channel for introducing substances.

16. A method for finding suitable conditions of chemical reactions, comprising the following method steps:
a) introduction of individual reaction batches into the autoclave modules,
b) successive adjustment of the setpoint pressures in the respective autoclave modules,
c) time division multiplex regulating of the pressures in the autoclave modules,
d) relaxation of the gas pressure in the device and removal of the reaction products for analysis.

17. The method as claimed in claim 16, characterized in that a time division multiplex measurement of the gas consumption in the autoclave modules is carried out by determining the pressure difference of the setpoint pressure and the actual pressure in reference volume chamber.

18. The method as claimed in one of claims 16 and 17, characterized in that the setpoint pressure in the reference volume chamber is adjusted via a pressure regulating chamber.

19. The method as claimed in one of claims 16 to 18, characterized in that the chemical reaction in the autoclave modules take place at a defined temperature.

20. The method as claimed in one of claims 16 to 19, characterized in that the chemical reactions in the autoclave modules take place under an inert gas.

21. The method as claimed in one of claims 16 to 20, characterized in that the filling of the autoclave modules with the respective reaction batch and/or the removal of the reaction products is carried out in an automated fashion.
